(19) United States
(12) Patent Application Publication
(10) Pub. No.: US 2011/0225609 A1
(43) Pub. Date: Sep. 15, 2011

(54) SYSTEM AND METHOD FOR MONITORING PROGRAM AVAILABILITY

(75) Inventors: Lacheng Li, Middlesex, MA (US); Minqing Xing, Hamilton, IN (US)

(73) Assignee: THOMSON LICENSING, LLC, Boulogne-Billancourt (FR)

(21) Appl. No.: 12/672,132

(22) PCT Filed: Aug. 7, 2008
(86) PCT No.: PCT/US08/09469

§ 371 Date: Feb. 4, 2010

Related U.S. Application Data
(60) Provisional application No. 60/963,942, filed on Aug. 8, 2007.

(51) Int. Cl. H04N 5/445; H04N 7/18

(52) U.S. Cl. 725/38; 725/85

(57) ABSTRACT

Modern broadcast services have a need for improving channel selection in an MDU network. A method is disclosed including the steps of receiving a request for a program, comparing the requested program to a stored list of available programs, and providing an alternative if the requested program is unavailable. An apparatus is disclosed including a user interface receiving a request for a program from a user, a controller comparing the requested program to a stored list of available programs, and a network interface receiving data relating to programs available from a source when available programs from the source change and transmitting the requested program if the controller determines that the requested program is available.

This application claims the benefit under 35 U.S.C. §119 of a provisional application 60/963,942 filed in the United States on Aug. 8, 2007.

### FIELD OF THE INVENTION

The present invention is directed toward network and device communications and more specifically to communicating program or channel availability between a settop box and gateway device in a Multiple Dwelling Unit (MDU) network.

### BACKGROUND OF THE INVENTION

This section is intended to introduce the reader to various aspects of art, which may be related to various aspects of the present disclosure that are described and/or claimed below. This discussion is believed to be helpful in providing the reader with background information to facilitate a better understanding of the various aspects of the present invention. Accordingly, it should be understood that these statements are to be read in this light, and not as admissions of prior art.

As most people are aware, satellite television systems have become much more widespread over the past few years. In fact, since 1994, more than twelve million American homes have become satellite TV subscribers. Most of these subscribers live in single-family homes where satellite dishes are relatively easy to install and connect. For example, the satellite dish may be installed on the roof of the house.

Many potential subscribers, however, live or temporarily reside in multi-dwelling units (“MDUs”), such as hotels or high-rise apartment buildings. Unfortunately, there are additional challenges involved with providing satellite TV services to the individual dwelling units within an MDU. It may be impractical and/or extremely expensive to provide and connect one satellite dish per dwelling. For example, in a high-rise apartment building with one thousand to apartments, it may be impractical to mount up to one thousand satellite dishes on the roof of the building. Some conventional systems have avoided these issues by converting the digital satellite television signal into an analog signal that can be transmitted via a single coaxial cable to a plurality of dwellings. However, these converted systems offer limited channels, have reduced quality compared to all-digital systems, and cannot provide the satellite TV experience to which users who live in single family houses are accustomed.

The distribution of satellite signals directly to individual dwellings in an MDU would permit the ability to provide the experience similar to single family home users but can further involve complications. For instance, distribution of satellite signals from a dish requires special distribution equipment and wiring, which is often not found in MDU establishments. The cost to retrofit the establishment may be significant.

It is also possible to create a system whereby each dwelling unit receives services using dedicated resources for receiving signals where these resources are located remotely. For example, the main tuning functions could be located in a central control room and a unique signal or service sent to each dwelling unit. This connection may be made using ethernet or co-axial cable that is distributed throughout the building. Ideally, for systems to distribute video content, each end user must have its own dedicated tuning and decoding circuit. This can be costly and inefficient, particularly for large MDU establishments. Even when an MDU system is configured to address the management and sharing of tuning resources between end users in a centrally located gateway, operational difficulties of managing user interfaces for channel selection can be a problem.

One such aspect of broadcast services, such as satellite services, which may be affected, involves the determination of program or channel availability. In typical service arrangements, a user's settop box (STB) acquires a program guide at initial startup or boot up. This program guide information may then be used for creation of the user's channel lists. All programs on the list are assumed to be available to the user all the time. In this arrangement, it is assumed that the satellite network availability does not change, thus it is sufficient for the STB to get the network availability information via the program guide.

However, in an MDU network, changes in channel availability may be made, or boot up of the gateway device may occur, without re-booting or startup of the client STB. In case the network becomes unavailable after the client STB has started or booted up, all the channels associated with this network become may unavailable to the user while still in the user's channel list. As a result, a user's channel up/down commands still step through these unavailable channels. In addition, certain channels may become unavailable due to issues with the network, not with the service provider. Channel unavailability due to the network also leaves the user a certain number of unavailable channels in the channel list. Further, the user may still proceed with a channel up/down command or a direct channel tuner command and not receive any feedback as to why the channel requested is not displayed. Therefore, there is a need for an improved system and method to communicate program availability in to a multiple dwelling unit network.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In one embodiment, a method is disclosed including the steps of receiving a request for a program, comparing the requested program to a stored list of available programs, and providing an alternative if the requested program is unavailable.

In another embodiment, an apparatus is disclosed which includes means for obtaining a list of available programs from a network, means for receiving a request for a program, means for comparing the request for the program to the list of available programs, and means for providing an alternative if the requested program is not available.

In a further embodiment, A network client device is described that includes a user interface receiving a request for a program from a user a controller coupled to the user interface, the controller comparing the requested program to a stored list of available programs, and a network interface coupled to the controller, the network interface receiving data relating to programs available from a source when available programs from the source change and transmitting the requested program only if the controller determines that the requested program is available.

### BRIEF DESCRIPTION OF THE DRAWINGS

In the drawings:

FIG. 1 is a block diagram of an embodiment of a satellite television MDU system of the present disclosure;

FIG. 2 is a block diagram of an embodiment of a STB of the present disclosure;

FIG. 3 is a flow chart of an embodiment of a process for communicating program updates in an MDU system of the present invention; and

FIG. 4 is a flow chart of an embodiment of a process for communication between a STB and an MDU gateway of the present invention.

The characteristics and advantages of the present invention may become more apparent from the following description, given by way of example.

### DETAILED DESCRIPTION OF THE PREFERRED EMBODIMENTS

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, to such as compliance with system-related and business-related constraints, which may vary from one implementation to another. For instance, the present embodiments may be modified in order to utilize signals provided through a different medium such as over the air terrestrial or cable transmission. Moreover, it should be appreciated that such a development effort might be complex and time consuming, but would nevertheless be a routine undertaking of design, fabrication, and manufacture for those of ordinary skill having the benefit of this disclosure. Throughout this disclosure the terms “channel” and “program” may be used interchangeably and in this context are to be treated as each being operated on equally by the present invention.

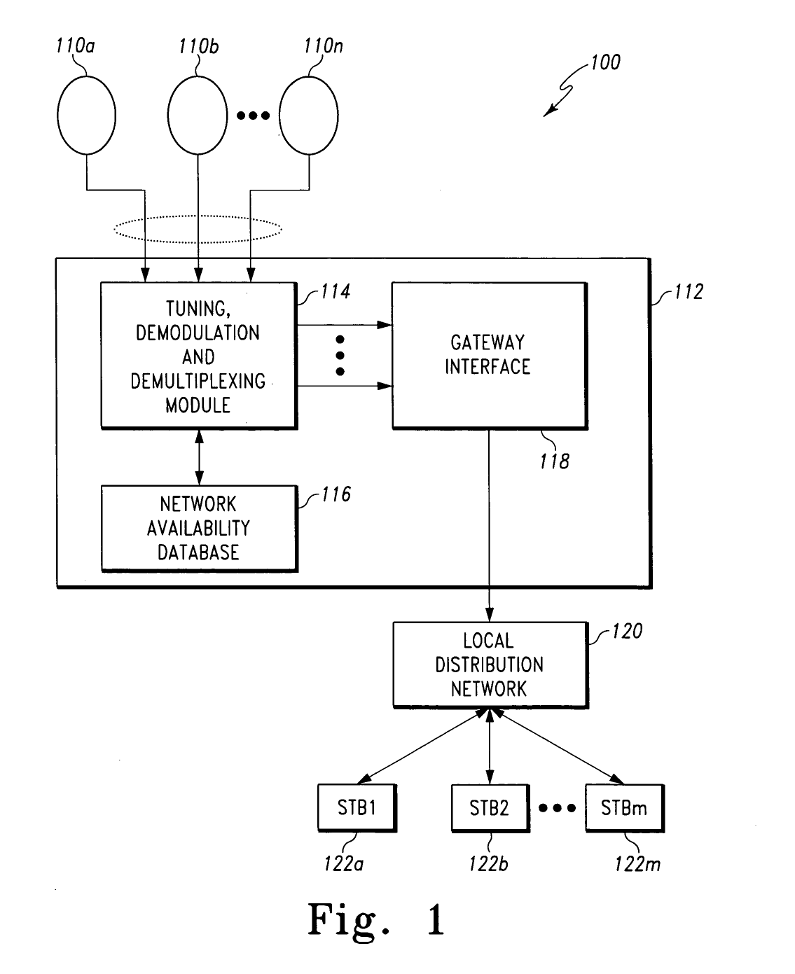

Turning to FIG. 1, a block diagram of an embodiment of a satellite television MDU system 100 of the present disclosure is shown. Receiving antennas 110a through 110n receive satellite signals from signal transponders located on one or more satellites. The number of receiving antennas 110a through 110n is dependent on, for instance, the number and/or location of satellites in use. Receiving antennas 110a through 110n receive audio, video and data signals supplied by a signal source and provide those signals to MDU gateway 112. Typically, the signal source is a service provider such as the satellite service provider DirecTV.

MDU gateway 112 provides the signal and communications interface between the service provider and the users in the MDU network. MDU gateway 112 includes a tuning, demodulation and demultiplexing module 114, a network availability database 116 and a gateway interface 118. The tuning, demodulation, and demultiplexing module 114 contains circuitry that receives all of the signals from antennas 110a through 110n tunes, demodulates, and demultiplexes portions of the signals based on inputs from the gateway interface 118 or other sections of MDU gateway 112. The tuning, demodulation, and demultiplexing module 114 may be implemented using sets of parallel circuits used for the tuning, demodulation, and demultiplexing of the incoming signals into individual channels or programs. The tuning, demodulation, and demultiplexing module 114 may not contain enough tuning resources or enough processing bandwidth to simultaneously recover all possible channels provided by the service provider. As a result, MDU gateway 112 may manage the allocation of tuning resources including making some channels or program unavailable from time to time.

Gateway interface 118 in MDU gateway 112 provides audio and video signals that have been tuned, demodulated, and demultiplexed along with other control and data signals such as network availability data drawn from network availability database 116 to a local distribution network 120. Local distribution network 120 delivers selected program and data information to each client STB 122a through 122m by way of any of several delivery methods and protocols, such as Internet Protocol (IP), coaxial cable, ethernet, or power line communication standards. It is important to note that each dwelling unit in the MDU may have one or more client STB and that the number or client STBs 122a through 122m may be greater than the number of receiving antennas 110a through 110n, the number of channels available from the service provider, or the number of tuning resources in MDU gateway 112.

In a preferred embodiment, channel information, program guide data, and program availability data are continually received and downloaded from the service provider to MDU gateway 112. The data, along with additional data that may be generated within MDU gateway 112 regarding its program/channel availability, are retained in network availability database 116. Whenever changes occur in the network availability database, whether due to changes in availability from the service provider or changes in availability from MDU gateway 112 or local distribution network 120, update information may be provided through a network multicast communication to each client STB 122a through 122m served by MDU gateway 112.

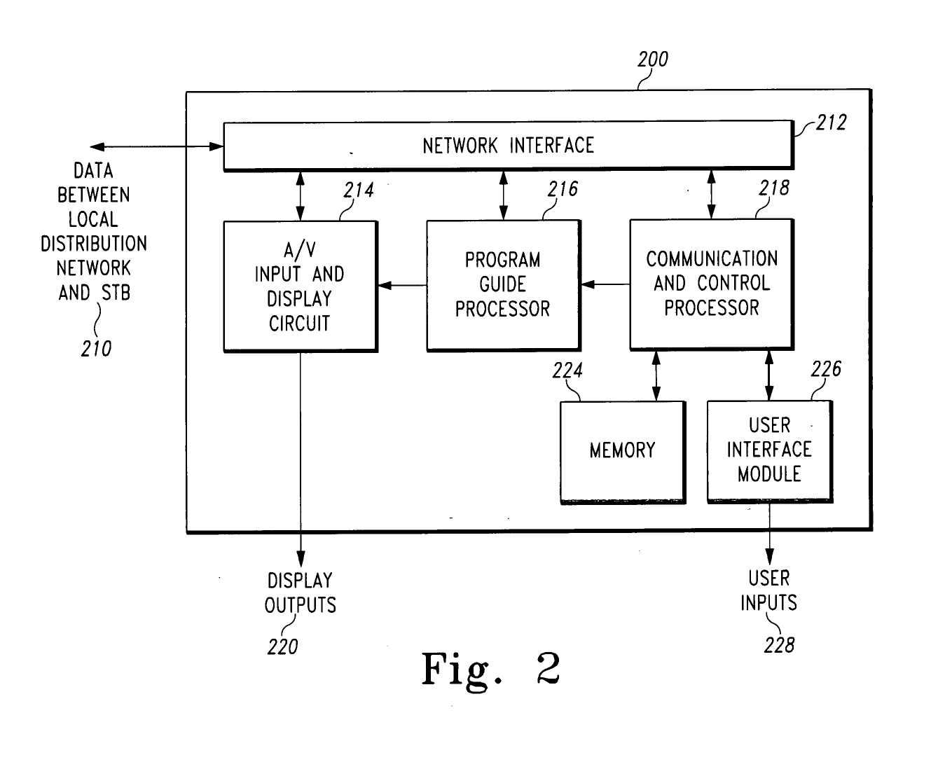

Turning to FIG. 2, a block diagram of an embodiment of a client STB 200 of the present disclosure is shown. It should be noted that client STB 200 is similar in operation to any client STB 122a through 122m described in FIG. 1. Client STB 200 interfaces to local distribution network 120 through network interface 212. The network interface 212 connects to A/V input and display circuit 214, program guide processor 216, and communication and control processor 218. The program guide processor 216 connects to the A/V input and display circuit 214. The communication and control processor 218 connects to the program guide processor 216 as well as to memory 224 and user interface module 226. Other blocks and connections, such as a power supply, power connections, and other control signals that are typically present are not shown. It is important to note that one or more of the blocks shown may be combined into larger processing blocks. For instance, all of the blocks may be combined into a single integrated circuit such as a microprocessor. Further, many of the functions described within the blocks may be implemented using hardware, software, firmware or any combination.

Network interface 212 parses the incoming signal from local distribution network 120 and provides the necessary signals to A/V input and display circuit 214, program guide processor 216 and communication and control processor 218. A/V input and display circuit 214 formats audio and video signals received from network interface 212 and outputs the appropriate audio and video display output signals 220. Program guide processor 216 compiles the interactive program guide data and communicates the data to A/V input and display circuit 214. The program guide information is typically displayed following a user request and is either overlaid on the video display output or replaces all or a portion of the current video display output.

Communication and control processor 218 maintains and manages the operation of client STB 200. Communications and control processor 218 is also responsible for managing memory 224 and user interface module 226. Memory 224 contains, among other things, the operating system that runs the set top box, the program guide data, and program availability data corresponding to the program availability data stored in the previously described network availability database 16 in gateway 12. User interface module 226 receives user input signals 228 as a result of user input commands for controlling the operation of the client STB 200. The user input signals 228 may be generated through a front panel display containing buttons, a keypad, or a touch screen. The user input signals 228 may also be generated through a remote control interface, not shown. The user input commands are interpreted by communication and control processor 218 and acted on by client STB 200. If necessary, the user input commands, such as program and channel requests, may further be provided to the network interface 212 and output through local distribution network 120 to gateway 112.

According to a preferred embodiment, when a user inputs a channel up or down command, for example, user interface module 226 interprets the command and sends it to communication and control processor 218. Communication and control processor 218 determines the next channel in the scan list and checks the program availability data stored in memory 224. If the requested program or channel is available, the command is sent through network interface 212 and local distribution network 20 to be acted on in gateway 12. If the requested channel is not available, communication and control processor 218 will automatically skip the originally requested channel and go to the following next channel in the scan list. This process will continue until a channel on the scan list is found that is available. In this manner the channel up/down operation is accomplished seamlessly without attempts to select channels that are not available.

According to another embodiment, if the user selects a specific channel by direct channel entry, the command is interpreted by user interface module 226 and sent to communication and control processor 218. Processor 218 interrogates memory 224 to ascertain the channel or program availability. If the requested channel or program is available, the request is sent through network interface 212 to MDU gateway 112. If the requested channel/program is not available, an on-screen message is generated and provided as part of the video component of display signal 220. In one embodiment, the display message informs the user that the requested program is not available. The message may further indicate the reason why the program is currently unavailable, such as service provider outage or network outage, and when the program may again be available. In another embodiment, the message might provide a suggestion of another channel or program that is similar to the one requested. For instance, the requested program may be compared and categorized by program type, such as sports, movies, or comedy, using information in the program guide, and alternative programs or channels in the same category may be displayed as a list of options for user selection. As a result, the user experience is improved by minimizing the display of a blank channel through the automatic tuning of an alternate program and further may be informed as to why the program selection was not available.

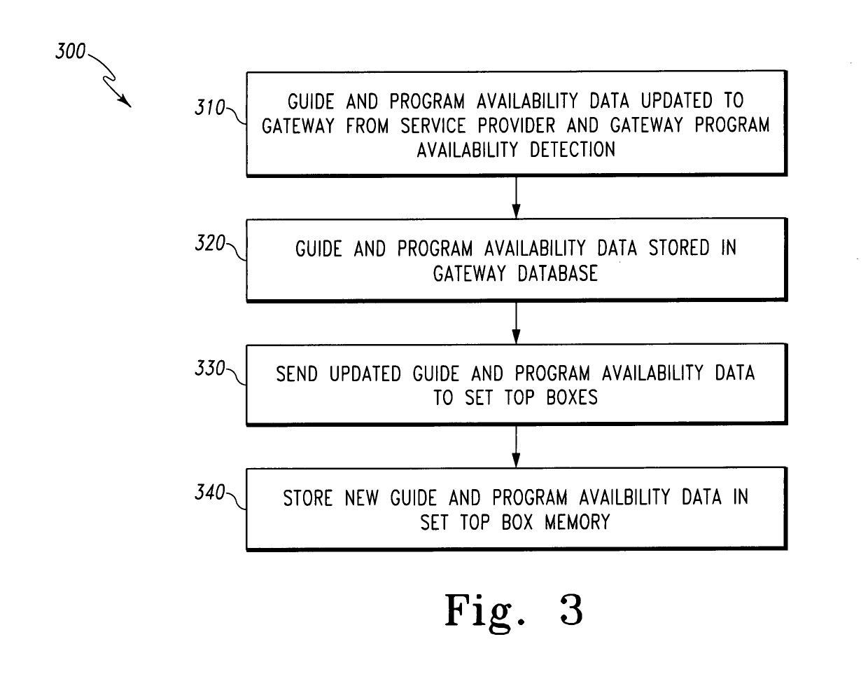

Turning now to FIG. 3, a flow chart of an embodiment of a process 300 for communicating program updates in an MDU system of the present invention is shown. Process 300 will be primarily described in relation to the MDU system 100 in FIG. 1. As described previously, program availability may change as a result of program changes made by the service provider or specific and temporary service provider program outages. Program availability may also change as a result of the operation of the MDU gateway 112 based on either gateway or network resource management. By providing as much information related to the program availability changes as possible to each client STB 122a through 112m, unnecessary network communications traffic and MDU gateway processing may be prevented.

At step 310, guide and program availability updates received from the service provider by the gateway MDU 112. The updates may be provided on a regular interval from the service provider. The gateway MDU 112 may use an availability detection system in order to assure that updates are properly identified and managed. Next, at step 320, the detected guide and program availability data is stored in the network availability database 116 in MDU gateway 112. In addition to the guide and program availability updates from the service provider, availability changes made by the MDU gateway 112 may also be stored in the network availability database 116. Other information relating to the reason for the availability change or the duration of the change including how long a program may be unavailable, may also be stored in the network availability database 116.

Next, at step 330, updated guide and program availability data, including service provider and MDU network generated changes, is sent to each client STB 122a through 122m. The program availability data may be sent on a regular timed interval or alternatively may be sent only when a service provider or MDU network availability data change occurs. Further, the MDU gateway 112 may transmit an entire map or set of availability data or alternatively may send only the incremental changes from the previously sent availability changes. Last, at step 340 new guide and program availability data is received by client STB 122a through 122m and stored in client STB memory such as memory 224. If the MDU gateway 112 transmits only changes related to current availability, then client STB 122a through 122m may further execute a memory comparison step in order properly update memory 224 and store the changes.

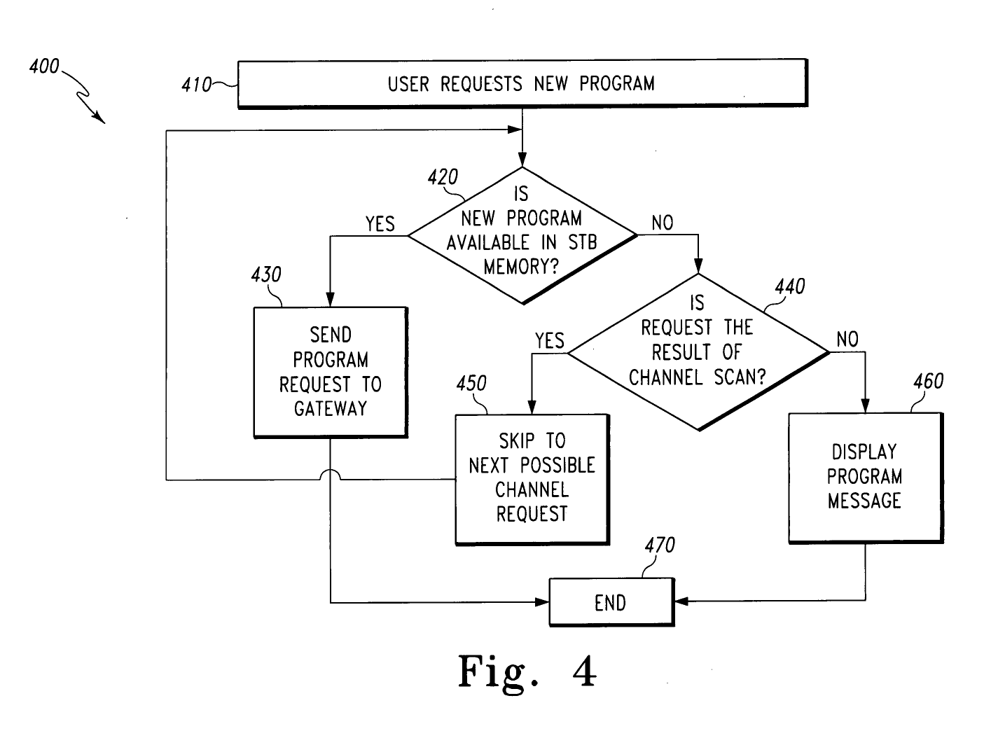

Turning to FIG. 4, a flow chart of an embodiment of a process 400 for communication between a client STB 200 and an MDU gateway 112 of the present invention is shown. Process 400 involves the communication between the client STB 200 and MDU gateway 112 as a result of a user program request and evaluation of the availability of the requested program in the network. As described earlier, the user may request a program that is not currently available due to a number or reasons including unavailability from the service provider, unavailability from the MDU gateway 112, and other network unavailability issues. In order to limit unnecessary use of network resources and bandwidth, Process 400 prevents unnecessary network requests when requested programs have become unavailable. Process 400 will primarily be described in relation to client STB 200 shown in FIG. 2.

At step 410, a user requests a new program. The user request may be made through a front panel command or remote control entry as previously described. Based on the user request at step 410, a decision is made, at step 420, whether the requested program is listed as a currently available program in the memory 224. As described above, guide information as well as program availability and changes based on availability updates may be provided to the client STB 200 from MDU gateway 112.

If, at step 420, the client STB 200 determines the currently requested program is available, then, at step 430, the program request is sent to the MDU gateway 112. If, at step 420, the STB determines the currently requested program is not available, then, at step 440, a second determination is made regarding the type of user request. If, at step 440, the request type is a channel scan input, then, at step 450, the next following program or channel in the particular channel scan list is selected. Typically, scan list user command entries are made using a channel up or channel down command. It is important to note that a number of different channel scan lists may be available and used. For example, possible channel scan lists may include all channels that were originally available from the service provider, all channels provided by the MDU gateway, or a user generated list of favorite channels. Each of these scan lists may be present and stored in memory in client STB 200 and also may be accessed through separate user input commands.

The next channel in the particular scan list is provided back to step 420 and evaluated as a replacement for the user request. The process then continues from step 420 as previously described until a program from the scan list that is determined to be available.

If, at step 440, the request type is not a channel scan, a display is produced, at step 460, providing a message to the user. The produced display message may, for instance, inform the user that the requested program is not available. The produced display message may be shown on a television screen or other display device connected to the client STB 200. The display message may also provide the reason why the program is currently unavailable if this information is stored in the memory 224 of client STB 200. Alternatively, the message might provide a suggestion of another channel or program that is similar to the one requested. For instance, a list of available programs extracted from the downloaded program guide information may be displayed based on some characteristics in common with the requested program. The characteristics may include, but are not limited to age category, length, program type (i.e. sports, comedy, movies) or recent viewing habits. The user may then choose to select one of the listed alternative programs. Process 400 ends, at step 470, after either a program request is sent to MDU gateway at step 430 or an availability display message is produced at step 460.

The decision step at step 440 provides alternatives to the requested program at step 410. In one case, an alternative may be to request an alternative program that is in the appropriate scan list. In another case, a message may be presented that provides information that the requested program is not available and, if possible, the reason it is not available. In both alternatives, the request for the program is not provided through the network back to the MDU gateway 112 such client STB 200 effectively prevents or otherwise does not communicate the information associated with the request from being sent. It should be understood that both alternatives shown at step 450 and step 460 may be provided and presented and the user may choose an appropriate action. Further, other alternatives may include presenting the user with a set of alternative programs to choose from if the currently requested program is not available.

While the present disclosure may be susceptible to various modifications and alternative forms, specific embodiments have been shown by way of example in the drawings and have been described in detail herein. However, it should be understood that the embodiments are not intended to be limited to the particular forms disclosed. Rather, the disclosure is to cover all modifications, equivalents and alternatives falling within the spirit and scope of the invention as defined by the following appended claims.

1. A method comprising the steps of:
receiving a request for a program;
comparing therequested program to a stored list of available programs; and
providing an alternative if the requested program is unavailable.

2. The method of claim 1 wherein the step of providing an alternative includes providing a program from the stored list of available programs that is different from the requested program.

3. The method of claim 2 wherein the stored list is a scan list of favorite programs.

4. The method of claim 3 wherein the step of providing a program from the stored list includes providing the next available program from the scan list of favorite programs.

5. The method of claim 1 wherein the step of providing an alternative includes providing a message for display.

6. The method of claim 5 wherein the message indicates that the requested program is not available.

7. The method of claim 5 wherein the message includes information about the reason that the program is not available.

8. The method of claim 1 further comprising the steps of:
obtaining information relating the availability of programs from a network; and
storing the information relating the availability of programs from the network.

9. The method of claim 1 further comprising the step of preventing communication of information related to the requested program over a network when the requested program is not available.

10. The method of claim 1 further comprising the step of providing a request over the network for the requested program when the requested program is available.

11. An apparatus comprising:
means for obtaining a list of available programs from a network;
means for receiving a request for a program;
means for comparing the request for the program to the list of available programs; and
means for providing an alternative if the requested program is not available.

12. The apparatus of claim 11 further comprising means for updating the list of available programs.

13. The apparatus of claim 11 further comprising means for storing the list of available programs.

14. The apparatus of claim 11 wherein the means for providing an alternative includes means for requesting an alternate program that is on the list of available programs.

15. The apparatus of claim 11 wherein the means for providing an alternative includes means for displaying a message if the requested program is not available.

16. The apparatus of claim 15 wherein the message indicates that the requested program is not available.

17. The apparatus of claim 11 further comprising means for not communicating the request for the program over the network when the requested program is not available.

18. The apparatus of claim 11 further comprising means for communicating over a network the request for a program when the requested program is available.

19. A network client device comprising:
a user interface receiving a request for a program from a user;
a controller coupled to the user interface, the controller comparing the requested program to a stored list of available programs; and
a network interface coupled to the controller the network interface receiving data relating to programs available from a source when available programs from the source change and transmitting the requested program only if the controller determines that the requested program is available.

20. The network client device of claim 19 further comprising a display circuit coupledto the controller, the display circuit providing a display message if the controller determines that the requested program is not available.

21. The network client device of claim 19 wherein the controller selects an alternate program from a scan list if the requested program is unavailable.
